(19) United States
(12) Patent Application Publication
(10) Pub. No.: US 2019/0152243 A1
(43) Pub. Date: May 23, 2019

(54) PRINTED AND TREATED MATERIAL AND PRODUCTION PROCESS THEREOF

(71) Applicant: Terraboost Media, LLC, Miami, FL (US)

(72) Inventors: Brian L Morrison, Miami, FL (US); Michael Chen, Miami, FL (US)

(73) Assignee: Terraboost Media, LLC, Miami, FL (US)

(21) Appl. No.: 16/112,412

(22) Filed: Aug. 24, 2018

Related U.S. Application Data
(60) Provisional application No. 62/549,427, filed on Aug. 24, 2017.

(51) Int. Cl. B41M 1/26; B41M 1/20; B65B 25/14; G09F 23/10

(52) U.S. Cl. CPC B41M 1/26; B41M 1/20; B65B 25/145; G09F 23/10; B65H 2301/5111; B65H 2701/1924; B65H 2553/42; B65H 2701/1242; B65H 2801/21

(57) ABSTRACT

The present invention discloses a system and method for printing a registered image on a wet wipe. The system includes a printing apparatus having a plurality of ink reservoirs configured to print a plurality of graphics on a fabric. At least one optical sensor is configured to sense the plurality of graphics and one or more perforating components form a plurality of perforations along a length of the fabric. One or more cutting components configured to form a plurality of cuts along a length of the fabric. A packaging apparatus packages the printed material.

### CROSS-REFERENCE TO RELATED APPLICATIONS

The present application claims the priority benefit of U.S. Provisional Application No. 62/549,427, filed Aug. 24, 2017 and U.S. Provisional Application No. 62/556,637, filed Sep. 11, 2017. The disclosures of the foregoing applications are incorporated herein by reference in its entirety.

### TECHNICAL FIELD

The present invention generally relates to wet wipes and similarly treated cloths and more specifically relates to treated cloths having printed materials thereon.

### BACKGROUND

Wet wipes and similarly treated cloths commonly include a porous fabric wetted with water soluble or water dispersible ingredients. These wipes are adapted to cleanse or treat the skin for various conditions in addition to being utilized in a variety of other domestic and industrial functions.

Wet wipes are commonly constructed of combinations of synthetic and natural fibers, such as polyolefin fibers, viscose fibers, and cotton fibers. Each piece of cloth may have a perforated pattern serving as one means for companies to differentiate themselves in the market. Further, some companies have printed a single image on the cloth, but these only have one image without accurate registration to fully utilize each cloth. The full potential of the product is not being used in relation to third-party marketing, brand promotion, and user enticement.

### SUMMARY OF THE INVENTION

This summary is provided to introduce a variety of concepts in a simplified form that is further disclosed in the detailed description of the invention. This summary is not intended to identify key or essential inventive concepts of the claimed subject matter, nor is it intended for determining the scope of the claimed subject matter.

In one aspect, a system for printing a registered image on a wet wipe comprises a printing apparatus having a plurality of ink reservoirs. The printing apparatus is configured to print a plurality of graphics on a fabric. At least one optical sensor configured to sense the plurality of graphics and communicate with a processor. The processor instructs the printing apparatus to print at least one graphic followed by drying the printed fabric. The fabric is then perforated, via one or more perforating components, at a predetermined distance interval according to the graphic dimensions. The fabric is then cut, via one or more cutting components, at a second predetermined distance interval and rolled.

In one aspect, the optical sensor provides a sensor output in response to detection of the registered graphic. The sensor output is transmitted to the one or more perforating components to appropriately dimension a plurality of perforations on the fabric. Similarly, the optical sensor provides a sensor output in response to detection of the registered graphic. The sensor output is transmitted to the one or more cutting components to appropriately dimension a plurality of cuts on the fabric.

Moreover, in accordance with a preferred embodiment of the present invention, other aspects, advantages, and novel features of the present invention will become apparent from the following detailed description in conjunction with the drawings.

### BRIEF DESCRIPTION OF THE DRAWINGS

A more complete understanding of the present invention and the advantages and features thereof will be more readily understood by reference to the following detailed description when considered in conjunction with the accompanying drawings wherein:

FIG. 1 illustrates a front elevation view of the printed material, according to some embodiments;

FIG. 2 illustrates a schematic of the printing apparatus, according to some embodiments;

FIG. 3 illustrates a perspective view of the optical sensor, according to some embodiments;

FIG. 4 illustrates a schematic of the optical sensor, according to some embodiments;

FIG. 5 illustrates a schematic of the perforation and registration system, according to some embodiments; and

FIG. 6 illustrates a front elevation view of a dispensing system, according to some embodiments.

### DETAILED DESCRIPTION

The specific details of the single embodiment or variety of embodiments described herein are to the described system and methods of use. Any specific details of the embodiments are used for demonstration purposes only and not unnecessary limitations or inferences are to be understood therefrom.

Any reference to “invention” within this document is a reference to an embodiment of a family of inventions, with no single embodiment including features that are necessarily included in all embodiments, unless otherwise stated. Furthermore, although there may be references to “advantage's” provided by some embodiments, other embodiments may not include those same advantages or may include different advantages. Any advantages described herein are not to be construed as limiting to any of the claims.

Before describing in detail exemplary embodiments, it is noted that the embodiments reside primarily in combinations of components related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second” and the like, may be used solely to distinguish one entity or element from another entity or element without necessarily requiring or implying any physical or logical relationship or order between such entities or elements.

In general, the invention described herein relates to treated substrates which can include but are not limited to treated cloths, wet wipes, sanitary wipes, makeup remover wipes, baby wipes, refreshing wipes, and household cleaning wipes among others known in the arts. These wipes 10 may be distributed within dispensers 600 positioned in public and retail locations, or in discreet containers for personal use, however, industrial use also further contemplated. Currently, the publicly placed dispensers 600 and personal containers may contain advertising material thereon, while the individual wipes have little markings or identifiers. While ink is commonly printed on substrates, the wet nature of the treated substrates poses numerous problems for the printing process. As used herein, the term “substrate” refers to the material the ink is printed on. This printed substrate can then be partitioned into wipes as described herein.

### Wet Wipe and Fabric Thereof

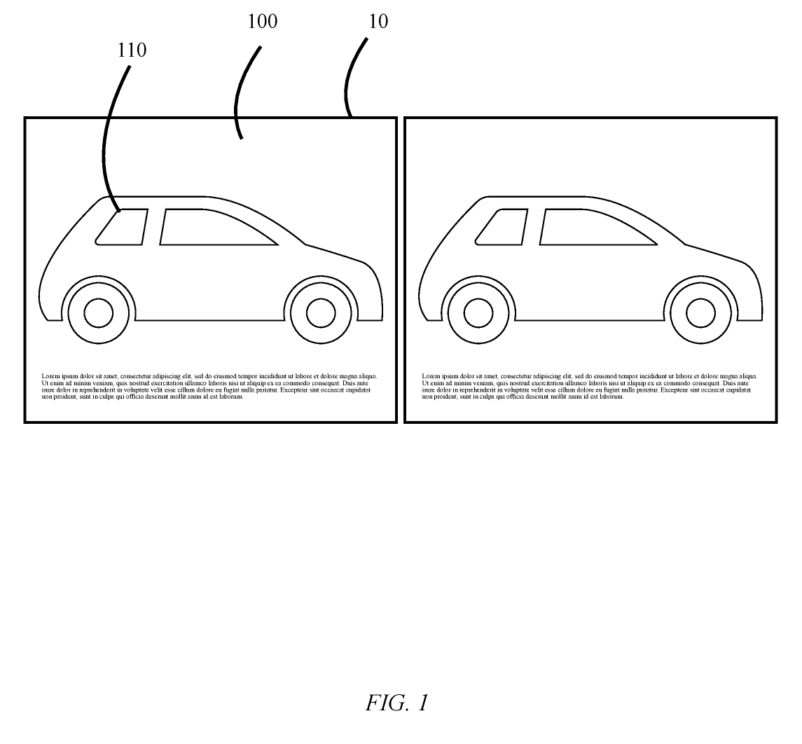

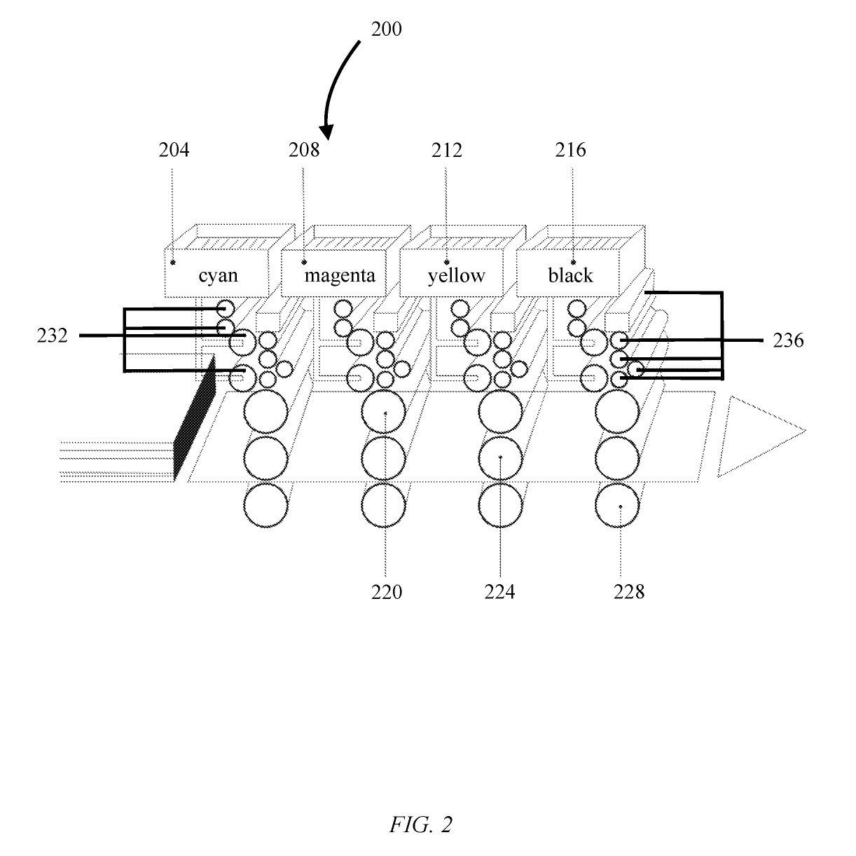

In an embodiment, treated substrate 100 has printed graphics 110 disposed thereon as illustrated in FIG. 1 and FIG. 2. The substrate 100 may be defined as a wet wipe 10 paper towels, thermal bonded non-woven fabric, hydrospun non-woven fabric, viscose spunlaced fabric, wood pulp spun lace fabric, and spunlaced bamboo fabric among others substrates known in the arts that may be adapted for skin care, or other domestic and industrial uses. The substrate has ink disposed thereon through the novel process described herein. Ink used may include multicarboxyl, aqueous polymer emulsion, organic pigment, solvents, and adjuvants. Ink and other ingredients must be non-toxic to a human and preferably non-toxic to other animals the user comes in frequent contact with.

The term “graphic” When used with reference to printing includes, but is not limited to, any type of design, mark, figure, picture, identification code, words, patterns or instructions. In an alternative embodiment, both sides of the substrate may be printed with different images.

In one aspect, the treated substrate 100 can be used to communicate with the consumer or end-user of the wet wipe 10. Particularly useful messages to communicate to the consumer are the instructions for the use of the product and a message to indicate that the stack of wipes is nearly finished.

In one embodiment, the substrate 100 can be treated with a composition including but not limited to cleaning compositions, wellness compositions, facial-care compositions, sanitizing compositions, disinfecting compositions, etc. The composition can also be applied uniformly or non-uniformly to the surfaces of the substrate. By non-uniform, it is meant that for example the amount, pattern of distribution of the composition can vary over the surface of the substrate.

The substrate 100 can contain an active agent-containing composition that contains an active agent to assist with the use of the wipe. The active agent-containing composition can be included with the nonwoven substrate to provide cleaning properties, disinfectant properties, deodorizing properties, moisturizing properties fragrance properties, etc. An active agent-containing composition that provides cleaning properties can be referred to as a cleaning composition. An active agent-containing composition that provides disinfectant properties can be referred to as a disinfectant composition. Additional compositions containing the various active agents can be referred to as, for example, abrasive compositions, moisturizing compositions, deodorizing compositions, etc. The active agent can be a surfactant, organic solvent, disinfectant, antibacterial agent, bacteriostat, pH adjuster, colorant, viscosity bodying agent, abrasive, moisturizer, perfume, deodorizer, or mixture thereof.

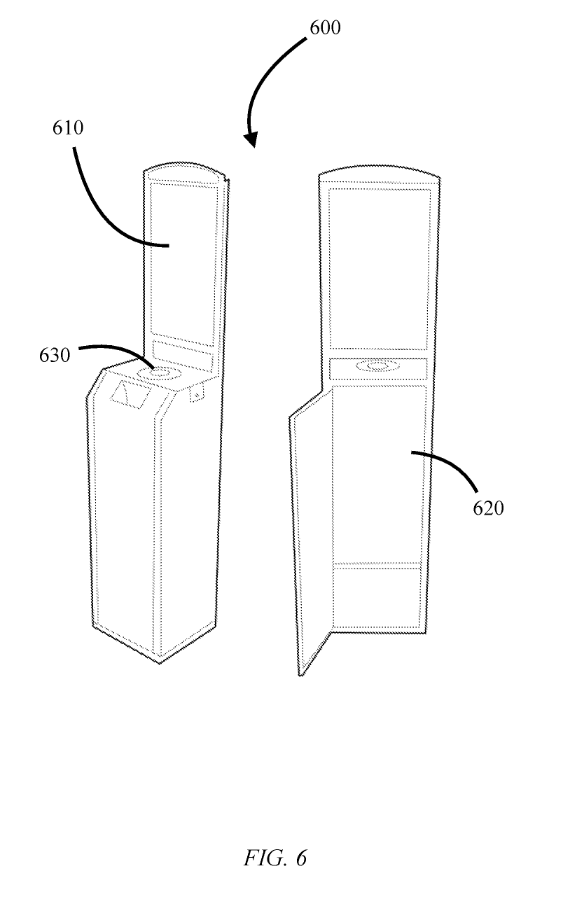

In embodiments, each wipe may be dispensed for personal or public use. For example, for personal use, a simple container having a dispenser 600 on top may contain any reasonable number of wipes 10 therein such that the container may be easily stored in the user's home. Further, the wipes 10 may be dispensed utilizing a dispenser 600 in a public environment, as shown in FIG. 6. This fixture can include a display 610, a loading portion 620, and a dispensing portion 630.

In an embodiment, the treated substrate 100 may be adapted for electronic display cleansing as well as surface cleansing as known in the arts.

### Process

The process described herein results in a treated substrate 100 having graphics 110 printed thereon. The treated substrate 100, as a result of the process, can be utilized in the domestic or industrial setting. Graphics 110 may be comprised of ink using four-color printing (Cyan, Magenta, Yellow, and Black) such that photograph quality prints may be achieved. Inks may be water based as known in the arts. In general, the process may be delineated into five steps comprising; printing, drying, perforating with registration (e.g., perforating at predetermined internals such that the printed material is fully present on each sheet), cutting, and rolling.

Printing should ideally be performed in a clean-room environment, which has preferentially been cleaned or purified by class 100,000 or ISO8 clean room standards. This environment is recommended as raw materials are open during the printing process which may get polluted, thus tampering with the final product. Printing is performed on an entire roll of substrate.

In a preferred embodiment, the maximum width of printable fabric is 1.16 meters.

In an embodiment and in reference to FIG. 2, a printing apparatus 200 is comprised of a plurality of ink reservoirs, 204, 208, 212, 216, each having a predetermined color of ink CMYK in a four-color system). While the illustrated embodiment in FIG. 2 is non-limiting, ink reservoir 204 corresponds with cyan ink, ink reservoir 208 corresponds with magenta ink, ink reservoir 212 corresponds with yellow ink, and ink reservoir 216 corresponds with black ink. The apparatus 200 is comprised of a plurality of plate cylinders 220, a plurality of blanket cylinders 224, and a plurality of impression cylinders 228. In the illustrated embodiment, each ink reservoir 204, 208, 212, 216 includes at least one plate cylinder 220, blanket cylinder 224, and impression cylinder 228. In a preferred embodiment, the circumference of the impression cylinder ranges from 20-100 CM dependent on the intended perforation (size) of the individual wipes. In an exemplary embodiment wherein wipes are intended to be perforated every 15 CM, the impression cylinders circumference is 75 CM. In this manner, each design may be repeated 5 times over the 75 CM total distance, allowing for 5 designs to be printed simultaneously for each roll of the wipe. After 75 CM, the design is repeated. In alternate embodiments, the spacing between each perforation is 11 CM, so the suggested impression cylinder circumference is a multiple of 11 such as 55 CM, 66 CM, or 77 CM.

Different or identical materials may be placed around the impression cylinders circumference which should be selected to maximize the efficiency of the process (e.g., the circumference can be divided by the length of each wipe). For example, if production of the wipe cabs for 6 CM wipe length, and 10 designs are needed, the impression cylinder circumference should be 60 CM, with every 6 CM having new art for maximum efficiency.

Drying is the second step in the five-step process. The ink may be water-based, water-insoluble, BZK, other common sanitizers, or alcohol based. The drying machine is in communication with the printing apparatus and perforation machine.

### Production Process for Roll Embodiment

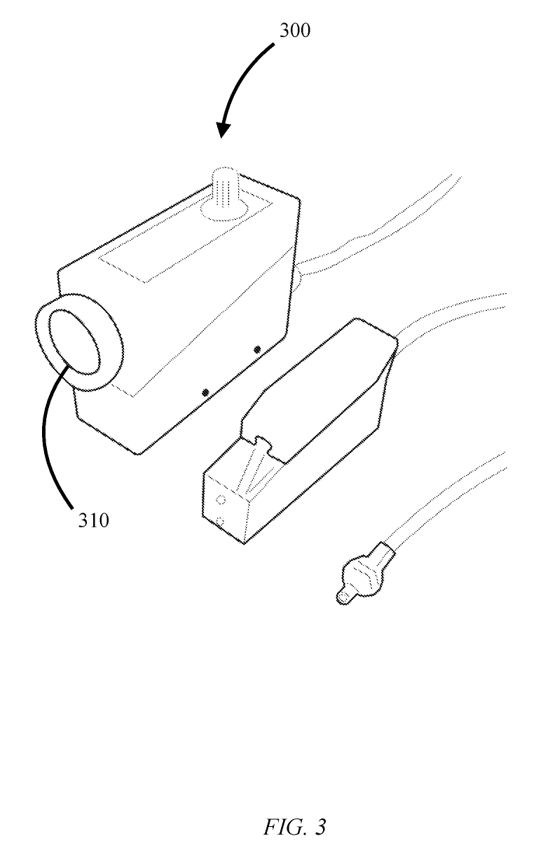

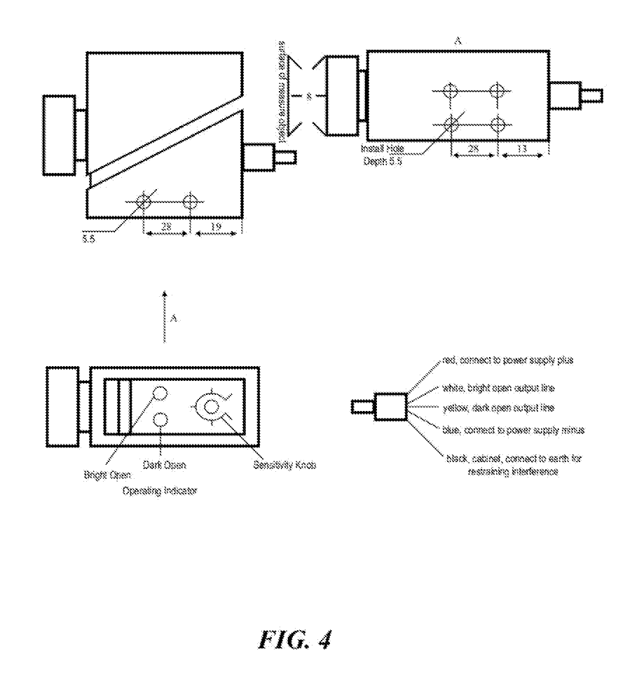

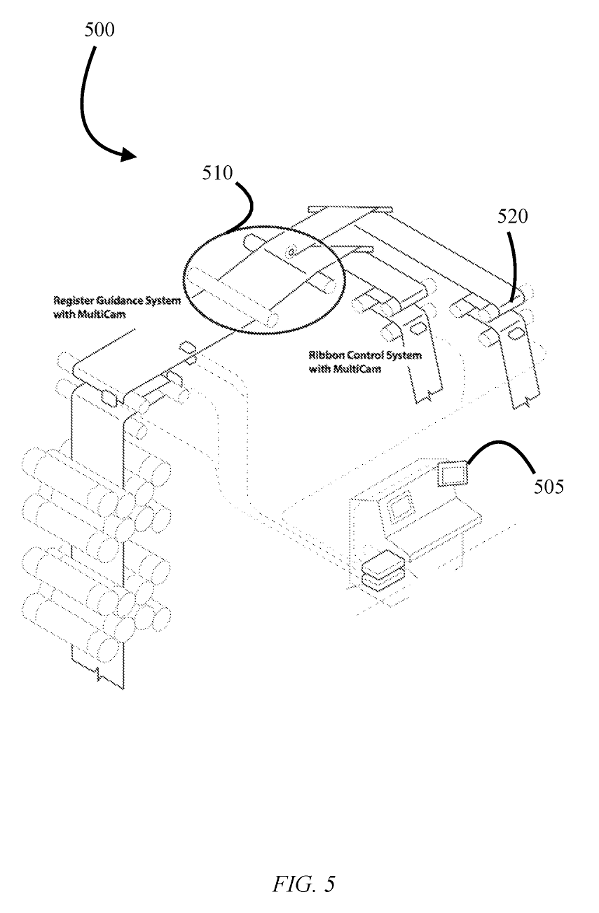

In an embodiment, and in reference to FIG. 3, FIG. 4, and FIG. 5, an optical sensor 300 will optically track the newly printed graphic on the fabric 100 permitting the printing assembly 200 to ensure the graphic 110 is in a suitable position on the substrate 100. In a preferred embodiment, Y-axis positioning is performed by utilizing a moving rail, perforation components (such as knives), and the spring controller to trigger the perforation components. These are all controlled by an optical sensor 300 (such as a color tracking sensor) such that once the graphic 110 is tracked and confirmed by the optical sensor 300, it causes the perforation components 510 to perforate the entire wide roll of the substrate and the perforated roll keeps running into the cutting components 520. The pre-set cutting components 520 then cut and divide the entire wide roll into smaller rolls. Y-axis positioning is comprised of a positioned, moving rail, perforation knives, and a spring controller. The spring controller stamps and triggers the activation of the perforation knives when indicated by the positioning system. The X axis is positioned between the impression cylinder and cutting knives. Both the impression cylinder and cutting knives have little to no tolerance on width, such that the x-axis is not repositioned for future processes.

In an embodiment, a positioning system 500, including a processor 505 a is pre-loaded with designs and can identify graphics by light sensation IC. A color tracking system within the optical sensor 300 tracks the colors using color tracking element 310 to ensure registration of the graphic 110 is maintained. The processor includes instructions for steps in the various embodiments presented herein.

The process can be modified after the printing step wherein wipes are individually cut and folded. Individually cut and folded wipes may be useful for retail sale. Further, a roll production method is disclosed, wherein wipes are not cut and folded. Each unique process is described herein.

In an embodiment, the large roll is automatically sent to cutting components pre-set to cut multiple rolls. The multiple roles are then re-rolled into tight individual rollers to be sent to the wetting step in the process.

### Production Process for Cut and Folded Wipes

The process for retail sale utilizes a 6 in 1 machine which comprises the steps of printing, drying, folding, cutting, watering and packaging.

The folding process as defined herein relates to the folding of individual wipes 100, rather than a large perforated roll. Folding, as defined herein, refers to folding a width of the wipe. Folding may be used for retail sale as specific folding configurations may be used to allow the user to easily receive a single wipe 100 from a dispenser. As a single roll of printed wipe 100 is rolled out of the printing apparatus, a folding machine is positioned between the printer and a cutting cylinder. The wipes are rolled into a Z-configuration and then folded once more in half. The Z fold is a non-inter folded format as each wipe is not folded within an adjacent. In alternate embodiments, a interfold, cross-fold, C hold, J-fold, or combinations thereof as known in the arts may be utilized.

In an embodiment, and related to the registration process in retail sale's production, an optical scanner 300 and a color tracking element 310 may be used to register graphics on the wipes. In this manner, after the wipe 10 is folded, the sensor recognizes the colors on the graphics 110 of the wipes 10 and controls the moving speed of the belt.

Cutting refers to cutting the overall length of the wipe. After the wipes are folded, two sets of cylinders are configured to cut the length of the wipe. In an embodiment, a first set of cylinders ensures the axial orientation of the roll is proper in relation to the second set of cylinders. Preferentially, the roll is parallel with the second set of cylinders. The second set of cylinders has a cutting member along its height. As the cylinder rotates, the cutting member separates the roll at predetermined intervals. The circumference of the second set of cylinders determines the length of the wipes. In an embodiment, a second cylinder circumference of 6 CM performs a cut every 6 CM on the wipe.

In another embodiment wherein a spunlaced substrate 100 is used, the position and speed of one or more cylinders may need to be adjusted at predetermined intervals due to the variable nature of the spunlaced material.

Next, the cut wipes are sent by a belt driven system to a watering machine. The wipes are wetted with a predetermined composition. Once the wipes are sufficiently wet, they are sent directly to a packing machine as known in the arts.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombination of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A system for printing a registered image on a wet wipe, the system comprising:
a. a printing apparatus including a plurality of ink reservoirs, the printing apparatus configured to print a plurality of graphics on a fabric;
b. at least one optical sensor configured to sense the plurality of graphics;
c. one or more perforating components configured to form a plurality of perforations along a length of the fabric;
d. one or more cutting components configured to form a plurality of cuts along a length of the fabric; and
e. a packaging apparatus to package the fabric.

2. The system of claim 1, wherein the printing apparatus includes a drying apparatus to dry the printed graphics.

3. The system of claim 1, wherein graphics are registered on the fabric.

4. The system of claim 2, further comprising the optical sensor providing a sensor output in response to detection of the registered graphic, wherein the sensor output is transmitted to the one or more perforating components to appropriately dimension a plurality of perforations on the fabric.

5. The system of claim 3, further comprising the optical sensor providing a sensor output in response to detection of the registered graphic, wherein the sensor output is transmitted to the one or more cutting components to appropriately dimension a plurality of cuts on the fabric.

6. The system of claim 5, further comprising the step of folding the fabric.

7. The system of claim 1, wherein the at least one graphic includes an advertisement.

8. The system of claim 1, wherein the fabric is treated with a composition.

9. A system for printing a registered image on a wet wipe, the system comprising:
a. a printing apparatus including a plurality of ink reservoirs, the printing apparatus configured to print a plurality of graphics on a fabric;
b. at least one optical sensor configured to sense the plurality of graphics, the at least one optical sensor communicating with a processor configured to perform the following:
i. printing, via the printing apparatus, at least one graphic on a fabric;
ii. drying the printed graphic;
iii. perforating the fabric at a first predetermined distance intervals;
iv. cutting the fabric at a second predetermined distance interval; and
v. rolling the fabric to a folding machine.
c. one or more perforating components configured to form a plurality of perforations along a length of the fabric;
d. one or more cutting components configured to form a plurality of cuts along a length of the fabric; and
e. a packaging apparatus to package the fabric.

10. The system of claim 9, further comprising the optical sensor providing a sensor output in response to detection of the registered graphic, wherein the sensor output is transmitted to the one or more perforating components to appropriately dimension a plurality of perforations on the fabric.

11. The system of claim 9, further comprising the optical sensor providing a sensor output in response to detection of the registered graphic, wherein the sensor output is transmitted to the one or more cutting components to appropriately dimension a plurality of cuts on the fabric.

12. The system of claim 11, further comprising the step of folding the fabric prior to the step of packaging the fabric.

13. The system of claim 9, wherein the at least one graphic includes an advertisement.

14. The system of claim 9, wherein the fabric is treated with a composition.

15. A method for producing a printed wet wipe, the method comprising the steps of:
a. printing, via a printing apparatus, at least one graphic on a fabric;
b. drying the printed graphic;
c. perforating the fabric at a first predetermined distance intervals;
d. cutting the fabric at a second predetermined distance interval; and
e. rolling the fabric to a folding machine.

16. The system of claim 15, further comprising the step of folding the fabric prior to the step of packaging the fabric.

17. The method of claim 15, further comprising the optical sensor providing a sensor output in response to detection of the registered graphic, wherein the sensor output is transmitted to the one or more perforating components to dimension a plurality of perforations on the fabric appropriately.

18. The system of claim 15, further comprising the optical sensor providing a sensor output in response to detection of the registered graphic, wherein the sensor output is transmitted to the one or more cutting components to appropriately dimension a plurality of cuts on the fabric.
